(19) United States
(12) Patent Application Publication
(10) Pub. No.: US 2002/0073085 A1
(43) Pub. Date: Jun. 13, 2002

(54) Database management systems and associated methods and computer program products

(75) Inventors: Daniel Michael O'Day JR., Los Angeles, CA (US); Mark Goldin, Los Angeles, CA (US); Wesley Walden Biggs, Santa Monica, CA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Elite.com, Inc.

(21) Appl. No.: 09/734,309

(22) Filed: Dec. 11, 2000

(51) Int. Cl. G06F 7/00

(52) U.S. Cl. 707/10

(57) ABSTRACT

An Internet-based database management system has a web server with a central database that can be modified in both a real-time mode and a non-real time mode. Regarding the real-time mode, the web server includes a web site that provides access to the central database, and a user of the system can use a web browser on their computer, which is remote from the web server, to access the central database via the Internet and the web site. Regarding the nonreal-time mode, the remote computer includes a remote database that can be modified in real-time while the remote computer is not connected to the Internet, and thereafter information is passed between the central database and the remote database via the Internet. The information passed between the central database and the remote database is streamed in both directions.

### FIELD OF THE INVENTION

The present invention relates to database management systems and, more particularly, to Internet-based data management systems.

### BACKGROUND OF THE INVENTION

It is important in many circumstances for people to be able to conveniently and efficiently track a variety of information. A variety of devices have been developed for this purpose and examples of the prior devices are described below.

U.S. Pat. Nos. 5,493,492 and 5,606,497 to Cramer et al. describe a portable timing device that has a memory which stores user selected information relating to a user, client and activity, along with corresponding start and stop times. The device periodically communicates with a central billing computer over a two way port which reads and writes to the memory in the device. The billing computer reads the stored and selected data via the port. The client list, the time of day, the activities and the user information may also be changed by means of the billing computer.

U.S. Pat. No. 5,991,742 to Tran discloses a portable computer system for recording time and expenses associated with activities performed by a service provider. The computer system is docked with a host computer for archival purposes. After docking, software located on the host computer supports the automatic synchronization of data between the portable computer system and the host computer. Changes made on the portable computer system and the host computer are reflected on both systems after synchronization.

U.S. Pat. No. 5,909,672 to Madore et al. discloses personal data collection devices that are carried by users for tracking the activities of the users. Each personal data collection device includes computer code that is downloaded thereto from a central storage and processing facility when the personal data collection device is docked therewith.

A disadvantage of each of the systems described by the above-referenced patents is that they do not capitalize upon the conveniences offered by the Internet. However, a conventional Internet-based data management system has been used by people who bill for their time and are reimbursed for expenses, to keep track of their time and expenses. Specifically, the conventional Internet-based system includes a web server having a web site for providing access to a central database that contains client, project, task code and expense code information. A user of the system can utilize the web browser on their computer to enter client, project, task code, expense code, time and expense information into the central database via the Internet and the web site in a real-time mode. However, such Internet-based systems can be difficult to use because it is not always possible or convenient to be connected to the Internet, and Internet connections are in some situations too slow.

Accordingly, there is a need for improved Internet-based database management systems that overcome problems resulting from it not always being possible or convenient to connect to the Internet, and Internet connections being too slow in some situations.

### SUMMARY OF THE INVENTION

In accordance with one aspect of the present invention, the above and other problems are solved by providing an Internet-based database management system having a web server with a central database that can be modified in both a real-time mode and a nonreal-time mode. In accordance with the real-time mode, the web server includes a web site that provides access to the central database, and a user of the system can use a web browser on their computer (i.e., the remote computer) that is remote from the web server to access and modify the central database via the Internet and the web site. In accordance with the nonreal-time mode, the remote computer includes a remote database that can be modified in real-time while the remote computer is not connected to the Internet, and thereafter the information in the remote and central databases can be at least partially synchronized by passing information between the central and remote databases, preferably by uploading and downloading via the Internet. Accordingly, the present invention provides the real-time mode to advantageously capitalize upon the convenience of the Internet, and provides the nonreal-time mode to advantageously compensate for situations when the Internet is not available or any available connection to the Internet is too slow.

In accordance with one aspect of the present invention, the nonreal-time mode of operation is facilitated by a software module that is downloaded from the web site to the remote computer.

In accordance with one aspect of the present invention, the downloaded software module is operative for preventing the user of the remote computer from manipulating at least some of the information in the remote database after a copy of that information is uploaded to the central database.

In accordance with one aspect of the present invention, the information passed between the central and remote databases for synchronization purposes is preferably streamed in both directions. This streaming advantageously reduces the time required for, and seeks to minimize any errors that might occur during, passing the information between the central and remote databases. Regarding this aspect more specifically, the uploading of information from the remote database to the central database preferably includes parsing the uploaded information at the web server prior to the uploaded information being stored upon any nonvolatile computer-readable storage medium of the web server. Similarly, the downloading of information from the central database to the remote database preferably includes parsing the downloaded information at the remote computer prior to the downloaded information being stored upon any nonvolatile computer-readable storage medium of the remote computer. For each of the above-referenced uploadings and downloadings, the above-referenced parsing and storage preferably occur after the completion of conventional operations associated with a network interface for introducing the information into the computer.

### BRIEF DESCRIPTION OF THE DRAWINGS

Having thus described the invention in general terms, reference will now be made to the accompanying drawings, wherein:

FIG. 1 is a block diagram that diagrammatically illustrates a database management system including a web server and multiple remote computers communicating with one another over the Internet, in accordance with a first embodiment of the present invention;

FIG. 2 is an environmental view of a block diagram that diagrammatically illustrates high level architecture of a computer that is representative of each of the remote computers and the web server of FIG. 1, in accordance with the first embodiment of the present invention;

FIG. 3 is a block diagram that diagrammatically illustrates high level architecture of nonvolatile computer-readable storage medium(s) of the web server of FIG. 1, in accordance with the first embodiment of the present invention;

FIG. 4 is a block diagram that diagrammatically illustrates high level architecture of nonvolatile computer-readable storage medium(s) of a representative remote computer of FIG. 1, in accordance with the first embodiment of the present invention;

FIG. 5 is a flowchart illustrating operations performed by a representative one of the remote computers of FIG. 1, in response to instructions from a user thereof, to access services of a web site that is based on the web server of FIG. 1, with the illustrated services including real time modifying of a central database of the web site and downloading a downloadable application program from the web site, in accordance with the first embodiment of the present invention;

FIG. 6 is a flowchart illustrating operations performed by the web site that is based on the web server of FIG. 1, in response to instructions from a representative one of the remote computers of FIG. 1, with the illustrated operations including real time modifying of the central database of the web site and downloading of the downloadable application program from the web site, in accordance with the first embodiment of the present invention;

FIG. 7 is a flowchart illustrating operations performed by the downloadable application program after it has been installed on a representative one of the remote computers of FIG. 1, with the operations including real time modifying of a remote database of the remote computer and nonreal time addition of information to the central database of the web server, in accordance with the first embodiment of the present invention;

FIG. 8 is a flowchart illustrating operations performed by the web site that is based on the web server of FIG. 1 in response to instructions from the downloaded application program executing on a representative one of the remote computers of FIG. 1, in accordance with the first embodiment of the present invention;

FIG. 9 is a flowchart illustrating streaming operations that are performed by both the web site while information is uploaded from the remote database to the central database, and the downloaded application program while information is downloaded from the central database to the remote database;

FIG. 10 diagrammatically and abstractly illustrates primary information, namely a Client/Project heading and entries thereunder, an Expense Code heading and entries thereunder, and an Activity Code heading and entries thereunder, that is contained in the central and remote databases, in accordance with the first embodiment of the present invention that is preferably directed to time and expense tracking;

FIG. 11 diagrammatically and abstractly illustrates secondary information, namely a representative, yet empty, expense record that is generally representative of expense records that are used to track expenses and are contained in the central and remote databases, in accordance with the first embodiment of the present invention;

FIG. 12 diagrammatically and abstractly illustrates secondary information, namely a representative, yet empty, time record that is generally representative of time records that are used to track time and are contained in the central and remote databases, in accordance with the first embodiment of the present invention;

FIG. 13 diagrammatically illustrates primary information, namely a Client/Project heading and entries thereunder, and a Tasks heading and entries thereunder, that is contained in the central and remote databases, in accordance with a second embodiment of the present invention that is directed to project management;

FIG. 14 diagrammatically illustrates secondary information, namely a representative, yet empty, expense/budgeting record that is generally representative of expense/budgeting records that are used to track expenses/budgeted items and are contained in the central and remote databases, in accordance with the second embodiment of the present invention; and

FIG. 15 diagrammatically illustrates secondary information, namely a representative, yet empty, time/status record that is generally representative of time/status records that are used to track time/status and are contained in the central and remote databases, in accordance with the second embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

High Level Overview

A first embodiment of the present invention preferably includes an Internet-based database management system having a web server with a central database that can be modified in both a real-time mode and a nonreal-time mode. Regarding the real-time mode, the web server includes a web site that provides access to the central database, and a user of the system can use a web browser on their computer (i.e., the remote computer) that is remote from the web server to access and manipulate the central database via the Internet and the web site. Regarding the nonreal-time mode, the remote computer includes a remote database that can be modified in real-time while the remote computer is not connected to the Internet, and thereafter the information in the remote and central databases can be at least partially synchronized by passing information between the central database and the remote database, preferably by uploading and downloading, via the Internet. The information passed between the central and remote databases is preferably streamed in both directions.

The database management system of the present invention can be used to manage a wide variety of information. For example and not limitation, according to the first embodiment of the present invention the database management system is used to track time and expense information, and according to a second embodiment of the present invention the database management system is used to track project-management information.

Overview of Architecture

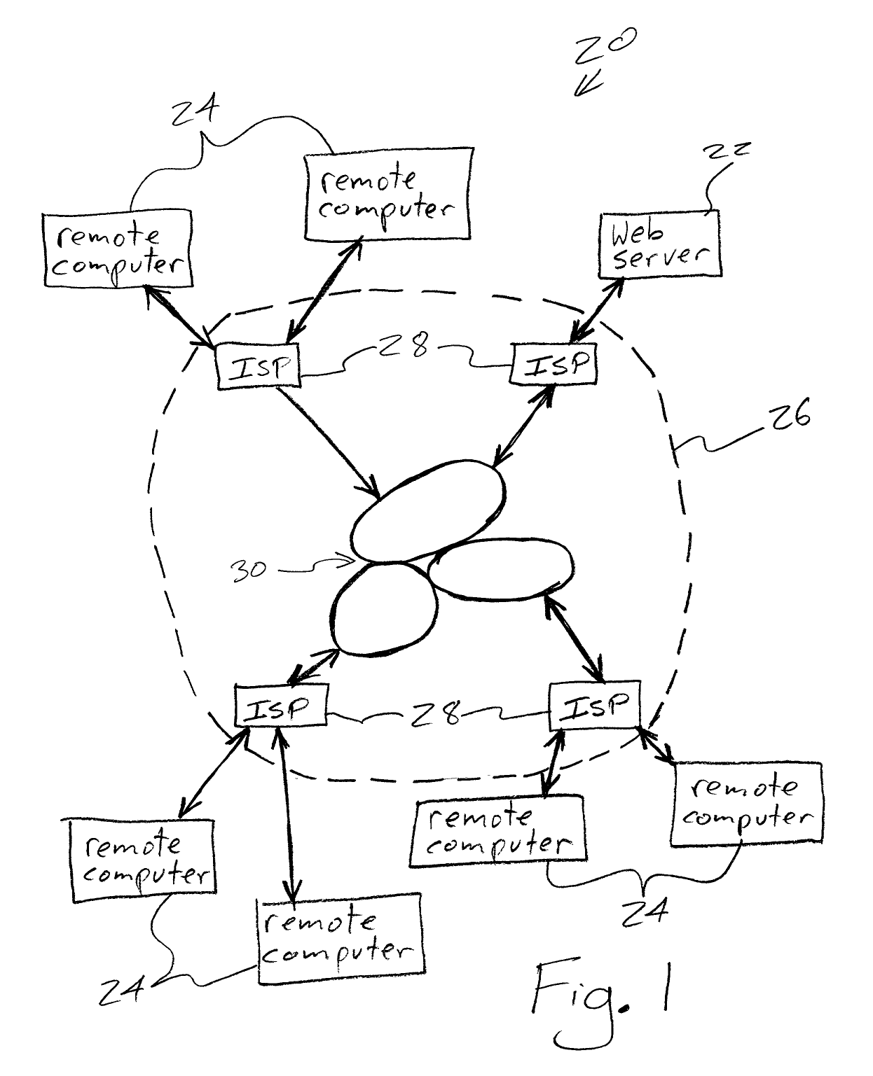

FIG. 1 is a block diagram that diagrammatically illustrates a database management system 20 that includes a web server 22 and multiple remote computers 24 that are capable of communicating with one another over the Internet 26, in accordance with the first embodiment of the present invention. The web server 22 can be more broadly characterized as a host computer or a central computer. The Internet 26 is conventional and its basic operations should be understood by those of ordinary skill in the art. The Internet 26 is a network of many thousands of packet-switched networks that use the Internet protocol (TCP/IP). The Internet 26 can be briefly described in the context of end users (for example the web server 22 and the remote computers 24), Internet service providers 28, and backbone providers 30.

Internet service providers (ISPs) 28 connect end users to Internet backbone networks. Backbone providers 30, which provide backbone networks, route traffic between ISPs 28 and interconnect with other backbone providers. ISPs 28 and backbone providers 30 typically have multiple points of interconnection. Some backbone providers 30 also serve as ISPs 28. Individual transmissions over the Internet 26 may be routed through multiple different providers.

The Internet 26 is a distributed, interoperable, packet-switched network. A distributed network has no one central repository of information or control, but is comprised of an interconnected web of “host” computers, each of which can be accessed from virtually any point on the network. That is, routers are positioned at connections in the network that are spread through the network, and the routers regulate the flow of data at each connection.

An interoperable network uses open protocols so that many different types of networks and facilities can be transparently linked together, and allows multiple services to be provided to different users over the same network. The Internet 26 also interconnects users of thousands of different local and regional networks, using many different types of computers. The interoperability of the Internet 26 is made possible by a previously adopted standard protocol, which is referred to as the TCP/IP protocol. The TCP/IP protocol defines a common structure for Internet data and for the routing of that data through the network.

A packet-switched network means that data transmitted over the network is split up into small chunks, or “packets.” A packet-switched network is “connectionless,” meaning that a dedicated end-to-end transmission path (or circuit) does not need to be opened for each transmission. Rather, each router calculates the best routing for a packet at a particular moment in time, given current traffic patterns, and sends the packet to the next router. When an end user sends information over the Internet 26, the data is first broken up into packets. Each of these packets includes a header which indicates the point from which the data originates and the point to which it is being sent, as well as other information.

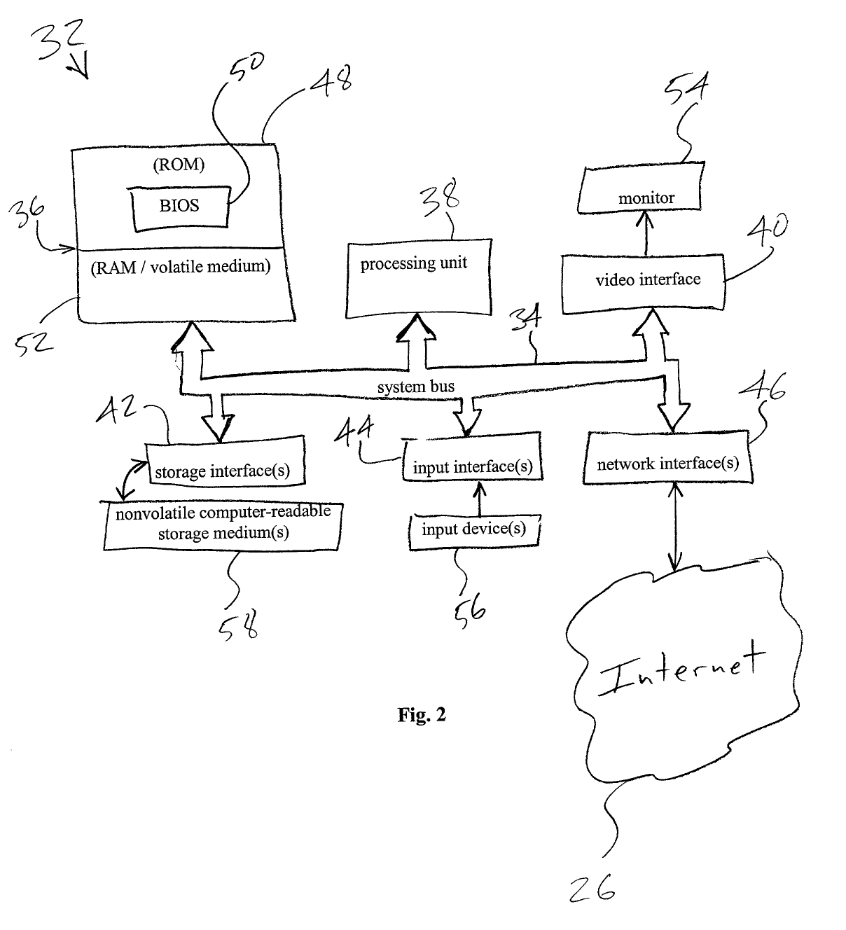

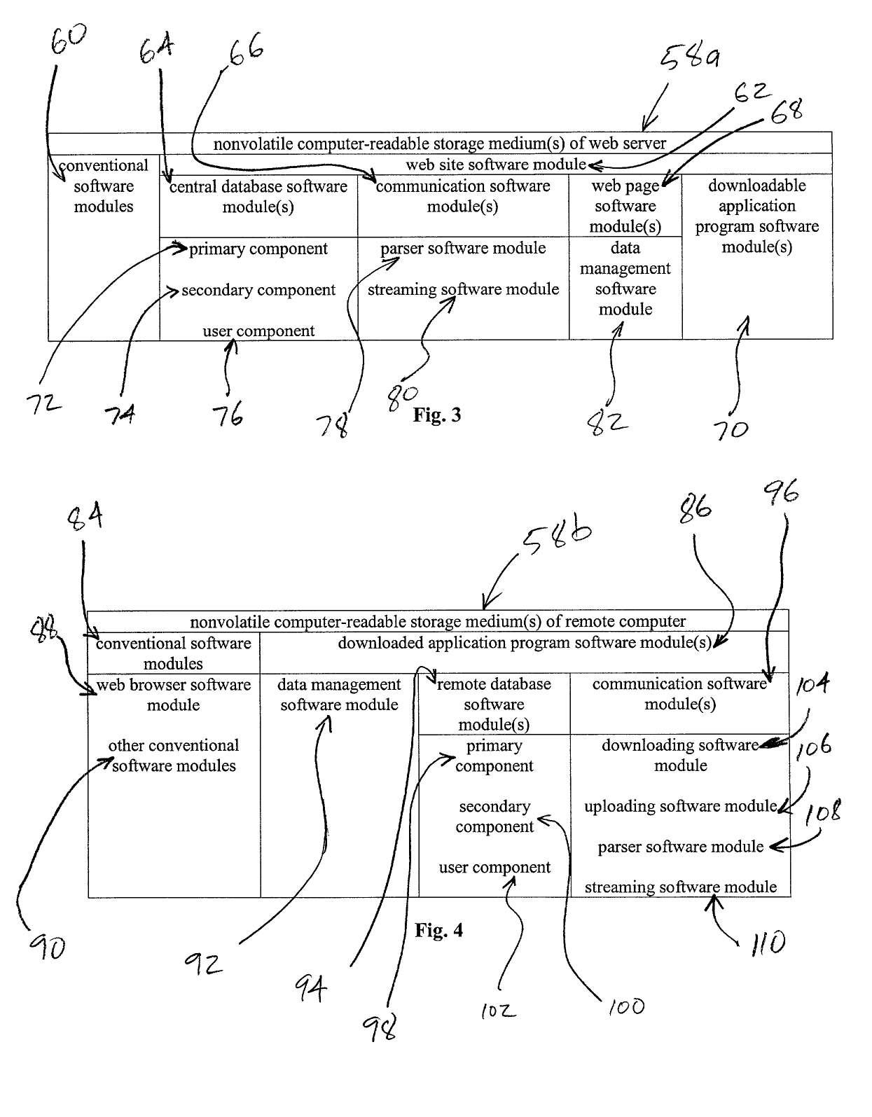

FIG. 2 is an environmental view that diagrammatically illustrates high level architecture of a computer 32 that is representative of each of the remote computers 24 and the web server 22 of FIG. 1, in accordance with the first embodiment of the present invention. Except for the inclusion of some of the specific software modules that are discussed in greater detail below with reference to FIGS. 3-4, the representative computer 32 and its operations are conventional and should be understood by those of ordinary skill in the art. Of course it is preferred for the web server 22 to have, but it is not required to have, considerably more power and capacity than the remote computers 24, as should be understood by those of ordinary skill in the art. Although the remote computers 24 are preferably not web servers 22, they can be any type of computer, including desk-top computers or portable computers, including hand-held computers such as Palm Pilot and Windows CE brand personal digital assistants (PDAs), or the like.

The conventional architecture of the representative computer 32 will now be briefly described, in accordance with the first embodiment of the present invention. The representative computer 32 can include different, additional, or less components, and may be arranged differently than described hereinafter, so long as the operations of the present invention can be performed at least generally as described in greater detail below. The representative computer 32 includes a system bus 34 connecting system memory 36, a processing unit 38, a video interface 40, storage interface(s) 42, input interface(s) 44, and network interface(s) 46. The system memory 36 includes read only memory (ROM) 48 that includes a basic input/output system (BIOS) 50. The system memory 36 also includes random access memory (RAM) 52, which is a volatile computer-readable storage medium, in accordance with the first embodiment of the present invention. The video interface 40 supplies information to a monitor 54 upon which screen displays are presented and viewable by a user of the representative computer 32. The input interface 44 receives inputs from input device(s) 56 that can be manipulated by a user of the representative computer 32. The input devices 56 can be one or more of any type of user input component, such as a keyboard, a mouse, or the like. The monitor 54 can also serve as an input device, such as by being in the form of a touch-screen monitor. The network interface 46 can be any type of conventional component for interfacing with the Internet 26 or for interfacing with a network that interfaces with the Internet 26, such as a modem, a network card, or the like. The network interface 46 is preferably directly connected or connected by wiring or the like to the system bus 34, or directly connected or connected by wiring or the like to a serial port that is directly connected or connected by wiring or the like to the system bus 34.

The storage interface 42 interacts with nonvolatile computer-readable storage medium(s) 58 that can include one or more magnetic disk drives, optical disk drives, or any other type of nonvolatile computer-readable storage medium. Except for some of the software modules contained by the nonvolatile computer-readable storage medium 58, at least some of which are also at times temporarily stored in RAM 52, the representative computer 32 is conventional. The software modules stored on the nonvolatile computer-readable storage mediums 58 of the remote computers 24 (FIG. 1) and web server 22 (FIG. 1) are discussed in greater detail immediately below with reference to FIGS. 34.

FIG. 3 is a block diagram that diagrammatically illustrates high level architecture of the nonvolatile computer-readable storage medium 58a of the web server 22 of FIG. 1, in accordance with the first embodiment of the present invention. The nonvolatile computer-readable storage medium 58a of the web server 22 includes conventional software modules 60 and a web site software module 62. The conventional software modules 60 that are required to support conventional operations of the web server 22 should be understood by those of ordinary skill in the art.

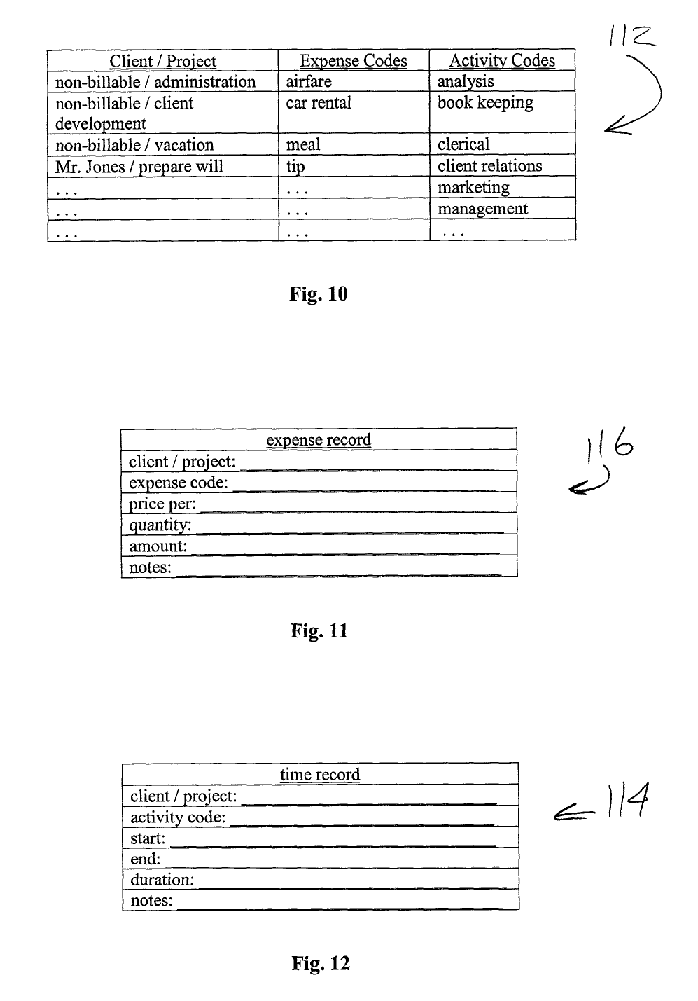

The web site 62 includes central database software module(s) 64, communication software module(s) 66, web page software module(s) 68, and a downloadable application program software module 70. The central database 64 can be characterized as including a primary component 72, a secondary component 74, and a user component 76. In accordance with the first embodiment of the present invention, the primary component 72 includes primary information, namely client, project, task code, and expense code information, as will be discussed in greater detail below with reference to FIG. 10; and the secondary component 74 includes secondary information, namely time and expense entries that are paired with client and project information, and optionally with task code information, expense code information, and other information, to define separate records, as will be discussed in greater detail below with reference to FIGS. 11-12. The user component 76 includes user information, namely login names, passwords, and the like, for all of the multiple different users of the database management system 20. For example, the user information can include access information for each of the respective users, because different users may have access to different groupings of the primary and secondary information. More specifically, the database management system 20 can support multiple users, with each having their own security levels and billing rate structures. Users can assign separate billing rates for individual timekeepers, clients, or projects.

The downloadable application program 70 is for having copies thereof downloaded to the remote computers 24 (FIG. 1). After copies of the downloadable application program 70 are downloaded to the remote computers 24 they can be used to manipulate the information in the central database 64 in a nonreal-time mode, as will be discussed in greater detail below with reference to FIGS. 4-8.

The communication module 66 includes a parser software module 78 and a streaming software module 80. The parser 78 is used when information is uploaded and downloaded from the remote computers 24 (FIG. 1) to the central database 64, and the streaming module 80 is used when information is uploaded from the remote computers to the central database, as will be discussed in greater detail below with reference to FIGS. 7-9. More specifically and during the uploading and downloading, the parser 78 is involved during communications between the central database 64 and the network interface 46 (FIG. 2) of the web server 22, so that the uploaded and downloaded information is parsed between a first format that is for communication with the network interface 46 of the web server 22 and a second format that is for being kept in the central database 64. Conversely and for example, the network interface 46 of the web server 22 is operative to receive communications originating from the Internet 26 and conventionally configure those communications so that they can be parsed by the parser 78. In accordance with one example of the first embodiment of the present invention, the parser 78 is a conventional “pipe delimited” parser, and in accordance with another example of the first embodiment of the present invention the parser 78 is a conventional Extensible Mark-up Language (XML) parser; and both of these conventional parsers should be understood by those of ordinary skill in the art.

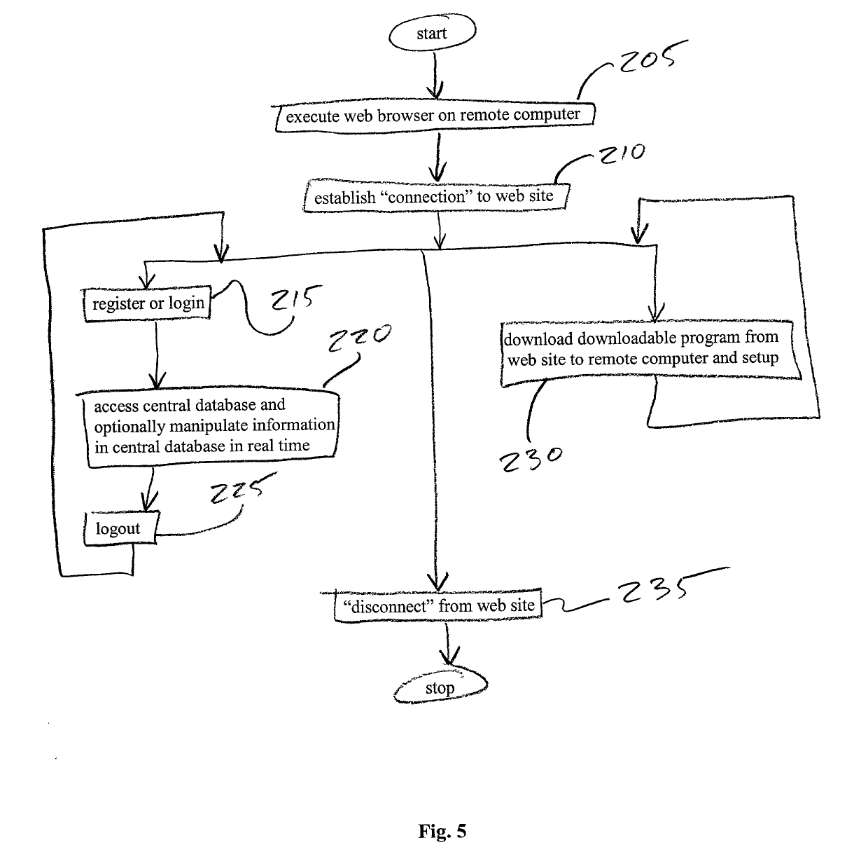

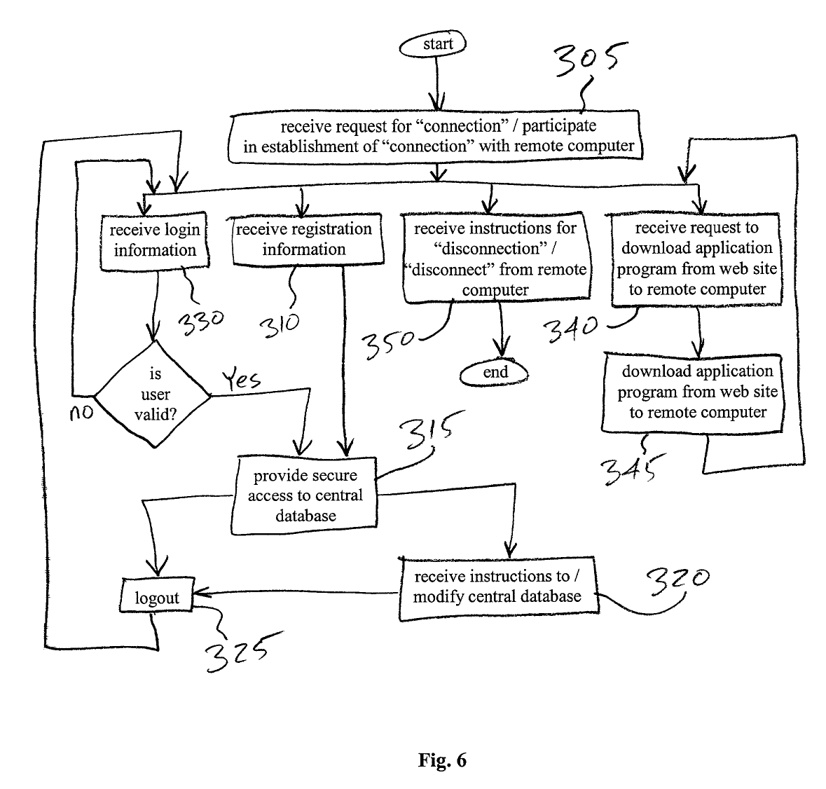

The web page module 68 is operative for providing web pages that can be viewed for example on monitors 54 (FIG. 2) of the remote computers 24 (FIG. 1). Those web pages can be navigated through and responded to by a user of the database management system 20 to access and manipulate the information in the central database 64 and to download the downloadable program 70, as will be discussed in greater detail below with reference to FIGS. 5-6. More specifically, the web page module 68 includes a data management software module 82 that is responsive to inputs from a user of the data management system 20 to access and manipulate information in the central database 64 in a real-time mode, as will be discussed in greater detail below with reference to FIGS. 5-6.

FIG. 4 is a block diagram that diagrammatically illustrates high level architecture of the nonvolatile computer-readable storage medium 58b of a representative one of the remote computers 24 of FIG. 1, in accordance with the first embodiment of the present invention. The nonvolatile computer-readable storage medium 58b of the representative remote computer 24 includes conventional software modules 84 and downloaded application program software module(s) 86. The conventional software modules include a conventional web browser software module 88 that is used in the accessing of and the manipulation of the central database 64 (FIG. 3) in the real-time mode, as will be discussed in greater detail with reference to FIGS. 5-6. The other conventional software modules 90 that are required to support conventional operations of the representative remote computer 24 should be understood by those of ordinary skill in the art.

The downloaded program 86 is a downloaded and set up copy of the downloadable program 70 (FIG. 3) of the web server 22 (FIG. 1), as will be discussed in greater detail below with reference to FIGS. 5-6. In accordance with an alternative embodiment of the present invention, the downloaded program 86 is not downloaded from the web server 22 and is provided by other means. The downloaded program 86 includes a data management software module 92, remote database software module(s) 94, and communication software module(s) 96.

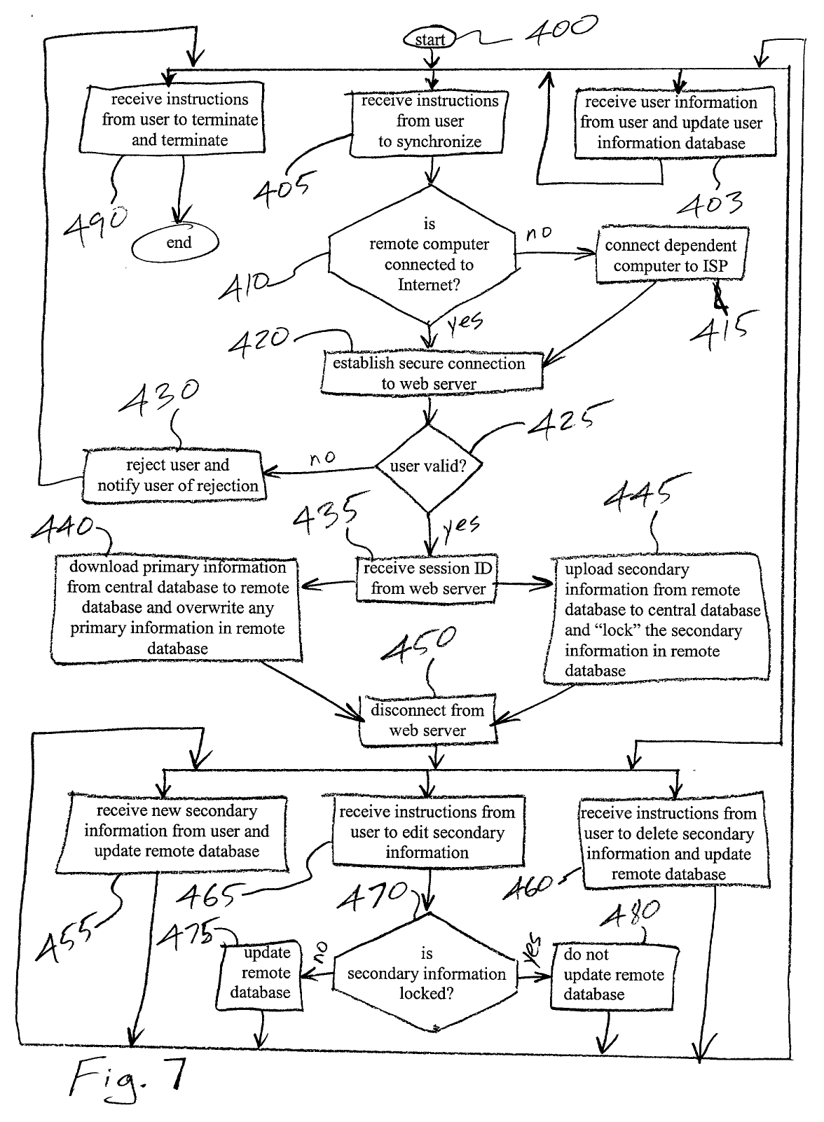

In accordance with the first embodiment of the present invention, the remote database 94 can be characterized as including a primary component 98, a secondary component 100, and a user component 102. In accordance with the first embodiment of the present invention, primary information associated with the primary component 98 is a copy of the primary information associated with the primary component 72 (FIG. 3) of the web server 22 (FIG. 1); therefore, the primary information associated with the primary component 98 is client, project, task code, and expense code information, as will be discussed in greater detail below with reference to FIG. 10. In accordance with the first embodiment of the present invention, secondary information associated with the secondary component 100 is like the secondary information associated with the secondary component 74 (FIG. 3) of the web server 22, meaning that the secondary information associated with the secondary component 100 includes time and expense entries that are paired with client and project information, and optionally with task code, expense code, and other information to define separate records, as discussed in greater detail below with reference to FIGS. 11-12. As discussed in greater detail below with reference to FIG. 7-8, the secondary information of the remote database 94 is periodically copied to the central database 64. The user component 102 includes user information, namely the login name and password for the user of the representative remote computer. The data management module 92 is responsive to inputs from a user to access and manipulate information in the remote database 94 in real time, as discussed in greater detail below with reference to FIG. 7.

The communication module 96 includes a downloading software module 104, an uploading software module 106, a parser software module 108, and a streaming software module 110. As discussed in greater detail below with reference to FIGS. 7-8, the downloading and uploading modules 104, 106 are respectively operative for at least initiating downloading of primary information from the central database 64 (FIG. 3) to the remote database 94 and uploading secondary information from the remote database to the central database. The parser 108 is involved in the uploading and downloading. More specifically and during the uploading and downloading for a representative one of the remote computers 24, the parser 108 is involved during communications between the remote database 94 and the network interface 46 (FIG. 2) of the remote computer 24, so that the uploaded and downloaded information is parsed between a first format that is for communication with the network interface 46 of the remote computer 24 and a second format that is for being kept in the remote database 94. Conversely and for example, the network interface 46 of the representative remote computer 24 is operative to receive communications originating from the Internet 26 and conventionally configure those communications so that they can be parsed by the parser 108. In accordance with one example of the first embodiment of the present invention, the parser 108 is a conventional “pipe delimited” parser, and in accordance with another example of the first embodiment of the present invention the parser 108 is a conventional Extensible Mark-up Language (XML) parser; and both of these conventional parsers should be understood by those of ordinary skill in the art. As will be discussed in greater detail below with reference to FIG. 7-9, the streaming software module 110 is preferably used when information is downloaded from the web server 22 (FIG. 1) to the remote computers 24.

Overview of Operations

The operations of the database management system 20 will now be briefly described with reference to FIGS. 1 and 3-4, in accordance with the first embodiment of the present invention. The web site 62 of the web server 22 is operative so that a user can utilize the web browser 88 on their remote computer 24 to enter primary and secondary information into the central database 64 via the Internet 26 in a real-time mode. In accordance with the first embodiment of the present invention, the primary information includes client, project, task code, and expense code information; and the secondary information includes time and expense entries that are grouped with at least some of the primary information to define records, as is discussed in greater detail below with reference to FIGS. 11-12.

In accordance with the first embodiment, the downloaded program 86 is operative SO that a user can enter information, namely secondary and user information, into the remote database 94 while disconnected from the Internet 26. Subsequently, the downloaded program 86 operates so that a copy of the secondary information in the remote database 94 is uploaded to the central database 64 via the Internet 26 and the web site 62. That is and in accordance with the first embodiment of the present invention, the downloaded program 86 is capable of operating in conjunction with the Internet 26 and the web site 62 so that secondary information, namely time and expense information, is entered into the central database 64 in a nonreal-time mode.

In accordance with the first embodiment of the present invention, selected data in the central and remote databases 64 and 94 is synchronized by communications carried out over the Internet 26 while the downloaded program 86 is executing on a representative one of the remote computers 24 and the user of the representative remote computer 24 selects a predetermined option presented on the monitor 54 of the remote computer by the downloaded program. The synchronization includes the above-mentioned uploading of the secondary information from the remote database 94 to the central database 64 via the Internet 26 and the web site 62. The synchronization also includes downloading via the Internet 26 and the web site 62 so that the portion of the central database 64 to which a user has access and the remote database 94 on the user's remote computer 24 contain the same primary information, namely client, project, task and expense code information. The primary information can preferably only be entered into the central database 64 during the real-time mode.

During the synchronizing, and in accordance with the first embodiment of the present invention, the information/data is preferably “streamed” back and forth between the remote and central databases 94 and 64. In accordance with the first embodiment of the present invention, the synchronization preferably does not include downloading of secondary information, namely time and expense information, from the central database 64 to the remote database 94. Therefore and in accordance with the first embodiment of the present invention, the central database 64 is the primary and complete repository for the primary and secondary information, such as for purposes of printing reports and bills. The web site 62 includes conventional software modules (not shown) that are operative for performing various conventional operations on the information in the central database 64, such as printing reports and bills.

The operations of the database management system 20 will now be described in greater detail and in accordance with the first embodiment of the present invention, with reference to the multiple flowcharts illustrated in FIGS. 5-9. Throughout the remainder of this Detailed Description of the Invention section of this disclosure, many of the operations described are respectively performed by software modules. In this context, it will be understood by those of ordinary skill in the art that reference to a software module performing an act is more specifically reference to the software module being executed and providing computer instructions that cause the performance of the act.

Operations of Remote Computer for Real Time Manipulation of Information in Central Database/Downloading Downloadable Application

FIG. 5 is a flowchart illustrating operations performed by a representative one of the remote computers 24, in response to instructions from a user thereof, to access services of the web site 62, with the illustrated services including accessing and real time manipulation of the information in the central database 64 and downloading the downloadable program 70, in accordance with the first embodiment of the present invention. The operations of the flowchart of FIG. 5 will now be described with reference to a representative one of the remote computers 24 and in accordance with the first embodiment of the present invention.

The web browser 88 of the representative remote computer 24 is executed at step 205 in response to actions taken by the user of the representative remote computer. The remainder of the operations of FIG. 5 are performed by the web browser 88 of the representative remote computer 24 in response to actions taken by the user of the representative remote computer. At step 210 the representative remote computer is “connected” to the web site 62. The actions taken by the user of the representative remote computer to initiate the steps of FIG. 5 that follow step 210 are responsive to and via options presented to the user by web pages of the web site 62 that are displayed on the monitor 54 of the representative remote computer 24. That is, the user of the representative remote computer 24 that is interacting with the web site 62 is presented with web pages in response to execution of the web page module 68 on the web server 22, and the user of the representative remote computer can select from and navigate through the web pages in the furtherance of initiating the steps of FIG. 5 that follow step 210.

At step 215 registration or login information is provided to the web site 62 so that secure access is gained to the central database 64 at step 220. Of course access to the central database 64 is not achieved unless suitable registration or login information is provided, as is discussed in greater detail below with reference to FIG. 6. The secure access provided in response to the registration or login information provided at step 215 is preferably established through the use of the HTTPS protocol, which is a conventional and generally secure protocol that should be understood by those of ordinary skill in the art. The information in the central database 64, namely the primary and secondary information, can be manipulated in real time at step 220. That is, acceptable presentation of registration or login information at step 215 initiates the real-time mode of operation at step 220. The real-time mode of operation is terminated at step 225 by logging out.

At step 230 instructions are provided to download the downloadable program 70 from the web site 62 to the representative remote computer 24, and the downloadable application program is set up to provide the downloaded program 86. The representative remote computer 24 “disconnects” from the web site 62 at step 235.

Operations of Web Site for Real Time Manipulation of Central Database/Downloading Downloadable Application

FIG. 6 is a flowchart illustrating operations performed by the web site 62 in response to instructions from the web browser 88 of a representative one of the remote computers 24, with the illustrated operations including real time modification of the central database 64 and downloading of the downloadable program 70, in accordance with the first embodiment of the present invention. The operations of the flowchart of FIG. 6 will now be described in accordance with the first embodiment of the present invention.

At step 305 of FIG. 6 a request for “connection” to the web site 62 is received and the web site participates in establishing a “connection” with the representative remote computer 24 from which the request was sent. Registration information is received at step 310, and in response secure access to the central database 64 is provided at step 315, which initiates the real-time mode. Access to the central database 64 is only provided if the registration information received at step 310 meets predetermined criteria. The secure access provided to the central database at step 315 in response to the registration or login information received at step 310 is preferably established through the use of the HTTPS protocol, which is a conventional and generally secure protocol that should be understood by those of ordinary skill in the art. The registration information received at step 310 is placed in the central database 64 and associated with the user information component 76 for future use when requests are received to enter the real-time mode at step 330, as is discussed in greater detail below.

At step 315 access is provided to the primary and secondary components 72 and 74 of the central database 64. The first time a user accesses the central database 64 at step 315, the central database may not be populated with secondary information and may or may not be populated with primary information. Instructions are received to modify the primary component 72 and/or secondary component 74 of the central database at step 320. More specifically, instructions are received to add, edit, or delete primary and/or secondary information of the central database 64 at step 320, and the instructions are carried out accordingly. At step 325 instructions are received to log the current user out of the real-time mode of operation and the user is logged out.

After an initial registration of a new user takes place at step 310 and thereafter the new user is logged out at step 325, access to the real-time mode is made available to that user via step 330. At step 330 login information is received and a determination is made at step 335 as to whether the user that this attempting to login is a valid user. That is, if the login information received in step 330 matches login information in the user component 76 of the central database 64, then the user is provided access to the primary and secondary components 72 and 74 of the central database 64 at step 315. Alternatively, if the login information received at step 330 is not valid, because it does not match with the appropriate user information in the user information component 76 of the central database 64, control is transferred back to the state that immediately follows the establishment of the connection with the representative remote computer 24 at step 305.

The web site 62 receives a request to download the downloadable program 70 at step 340, and at step 345 that application is downloaded from the web site to the remote computer 24 from which the request at step 340 was received. At step 350 instructions for “disconnecting” are received and the web site 62 “disconnects” from the remote computer 24 from which the instructions for disconnection were received.

Although not illustrated in FIG. 7, in accordance with the first embodiment of the present invention, the web site 62 can operate conventionally to utilize the information in the central database 64 to produce reports and bills that are based in part upon entries received at step 320.

Operations of Downloaded Program for Nonreal Time Manipulation of Central Database

FIG. 7 is a flowchart illustrating operations performed by the downloadable program 70 after it has been downloaded to, installed on, and thereafter executed on a representative one of the remote computers 24 (i.e., operations of the downloaded program 86), with the operations including the nonreal time addition of information to the central database 64, in accordance with the first embodiment of the present invention. The operations of the flowchart of FIG. 7 will now be described with respect to a representative remote computer 24 upon which the downloaded program 86 is executing, in accordance with the first embodiment of the present invention.

At step 403 of FIG. 7 user information is received from the user of the representative remote computer 24 upon which the downloaded program 86 is executing, and the user information is stored in the user component 102 of the remote database 94. Step 403 must be performed the first time the downloaded program 86 is executed, but is not required to be performed thereafter unless a different user desires to use the same copy of the downloaded program 86. It may also be necessary for the URL or IP address of the web site 62 to be input at step 403.

At step 405 instructions are received from the user to synchronize. A determination is made at step 410 as to whether the representative remote computer 24 is connected to the Internet 26. If it is determined at step 410 that the representative remote computer 24 is not connected to the Internet 26, then the representative remote computer is connected to an Internet service provider (ISP) 28 at step 415, and thereafter a secure connection to the web server 22 is established at step 420. The secure connection established at step 420 is preferably established through the use of the HTTPS protocol, which is a conventional and generally secure protocol that should be understood by those of ordinary skill in the art.

At step 425 a determination is made as to whether the user information contained in the user component 102 of the remote database 94 matches user information in the user component 76 of the central database 64. If the user information does not match, the user is rejected and notified of the rejection at step 430, and control is transferred to the state that exists at the start 400 of operations of FIG. 7. When it is determined that the user is valid at step 425, control is transferred to step 435, where a session identification number (ID) is received from the web site 62, and that session ID is used throughout the current session.

From step 435 control is transferred to step 440 and/or step 445, depending upon a predetermined selection. The information regarding the predetermined selection is received at the most recent prior occurrence of step 405. More specifically, the instructions received regarding synchronizing at step 405 include instructions to download primary information from the central database 64 to the remote database 94 and/or upload secondary information from the remote database to the central database. Accordingly, steps 440 and 445 are both performed subsequent to step 435 if instructions are received to both download and upload at step 405. In contrast, only step 440 is performed after step 435 if instructions are received solely to download at step 405. Similarly, only step 445 is performed after step 435 if instructions are received solely to upload at step 405.

At step 440 a copy of the primary information that the current user is allowed access to is downloaded from the central database 64 to the remote database 94 and any/all primary information previously in the remote database is overwritten with the newly downloaded primary information. At step 445 a copy of secondary information in the remote database 94 is uploaded to the central database 64, and the secondary information uploaded from the remote database is locked in the remote database so that it can no longer be modified, but it can still be deleted, as will be discussed in greater detail below with reference to steps 465, 470, 475, and 480. There will not be any secondary information to upload from the remote database 94 to the central database 64 during the first pass through step 435. Preferably there will be multiple passes through step 435 for each user of the system of the present invention. Regarding the uploading at step 445 more specifically and in accordance with the first embodiment of the present invention, the secondary information more specifically includes time cards or records and expense cards or records, as is discussed in greater detail below with reference to FIGS. 11-12, and options are provided and responded to so that the time cards and/or the expense cards are uploaded at step 445.

The connection with the web server 22 is terminated at step 450. New secondary information is received from the user at step 455, and that new secondary information is added to the remote database 94 at step 455. Instructions to delete selected secondary information from the remote database 94 are received from the user at step 460, and that selected information is deleted from the remote database at step 460. Instructions are received from the user to edit secondary information in the remote database 94 at step 465. At step 470 a determination is made as to whether the secondary information that was requested to be edited at step 465 is locked, with the locking occurring at step 445 as discussed above. If it is determined that the secondary information that the user is attempting to edit is locked, then that secondary information is not modified in the remote database 94, as indicated by step 480. In contrast, if it is determined that the secondary information that the user is attempting to edit in the remote database 94 is not locked, control is transferred to step 475 where that secondary information is edited according to the user's instructions.

At step 490 instructions are received from the user to terminate the session and the session is terminated by terminating execution of the downloaded program 86.

In accordance with the first embodiment of the present invention, it is necessary for at least some primary information to be included in the remote database 94 prior to the user being able to introduce any secondary information into the remote database, because secondary information must be paired with primary information to create records, as discussed in greater detail below with reference to FIGS. 11-12. Also in accordance with the first embodiment of the present invention, it is preferred for the remote database 94, which is preferably part of the downloaded program 86, not to include any primary or secondary information when the downloaded program is initially downloaded and set up. Accordingly and in accordance with the first embodiment and for each downloaded program 86, the first occurrence of operations for adding, editing or deleting secondary information from the remote database 94 respectively at steps 455, 465, and 460 must be preceded by the downloading of primary information from the central database 64 to the remote database 94 at step 440. On a similar note, operations of uploading secondary information from the remote database 94 to the central database 64 at step 445 cannot occur until after the remote database is populated with secondary information.

Generally described and in accordance with the first embodiment of the present invention, the downloaded program 86 advantageously facilitates the entry of secondary information into the remote database 94 of a representative remote computer 24 by a user while the representative remote computer is not connected to the Internet 26, and thereafter the information entered into the remote database offline can be conveniently upload to the central database 64. More specifically and in accordance with the first embodiment of the present invention, the downloaded program 86 can be used to enter time using a convenient timer feature for precise tracking, to enter expenses, view time and expense entries by project and by day, and review a list of existing projects.

Operations of Web Site for Nonreal Time Manipulation of Central Database

FIG. 8 is a flowchart illustrating operations performed by the web site 68 in response to instructions received from the downloaded program 86 executing on a representative one of the remote computers 24, in accordance with the first embodiment of the present invention. The operations of the flowchart of FIG. 8 with respect to a representative one of the remote computers 24 will now be described in accordance with the first embodiment of the present invention.

At step 505 a request for a secure “connection” with the representative remote computer 24 is received, and the secure “connection” is established. The secure connection of step 505 is preferably established through the use of the HTTPS protocol, which is a conventional and generally secure protocol that should be understood by those of ordinary skill in the art. At step 510 user information is received along with a request to validate the received user information, and the user component 76 of the central database 64 is queried accordingly. A determination is made at step 515 as to whether the user information received at step 510 is valid. The user information received at step 510 is valid if it matches user information in the user component 76 of the central database 64. If it is determined at step 515 that there is a match between the user information received at step 510 and the user information contained in the user component 76 of the central database 64, control is transferred to step 520 where the session identifier (ID) is established and sent to the representative remote computer 24.

Instructions are received at step 525 to download primary information from the central database 64 to the representative remote computer 24, and the downloading is carried out accordingly. This downloading can be characterized as allowing the user of the representative remote computer 24 to update the remote database 94 of the representative remote computer in nonreal time. Secondary information being uploaded from the remote database 94 is received at step 530, and that information is uploaded to the central database 64 accordingly. The web site 62 is “disconnected” from the representative remote computer 24 at step 535.

If it is determined at step 515 that there is not a match between the user information received at step 510 and the user information contained in central database 64, control is transferred to step 540, where a rejection notification is transmitted to the representative remote computer 24, and thereafter control is transferred to step 535 so that the web site 62 is “disconnected” from the representative remote computer.

Streaming Operations

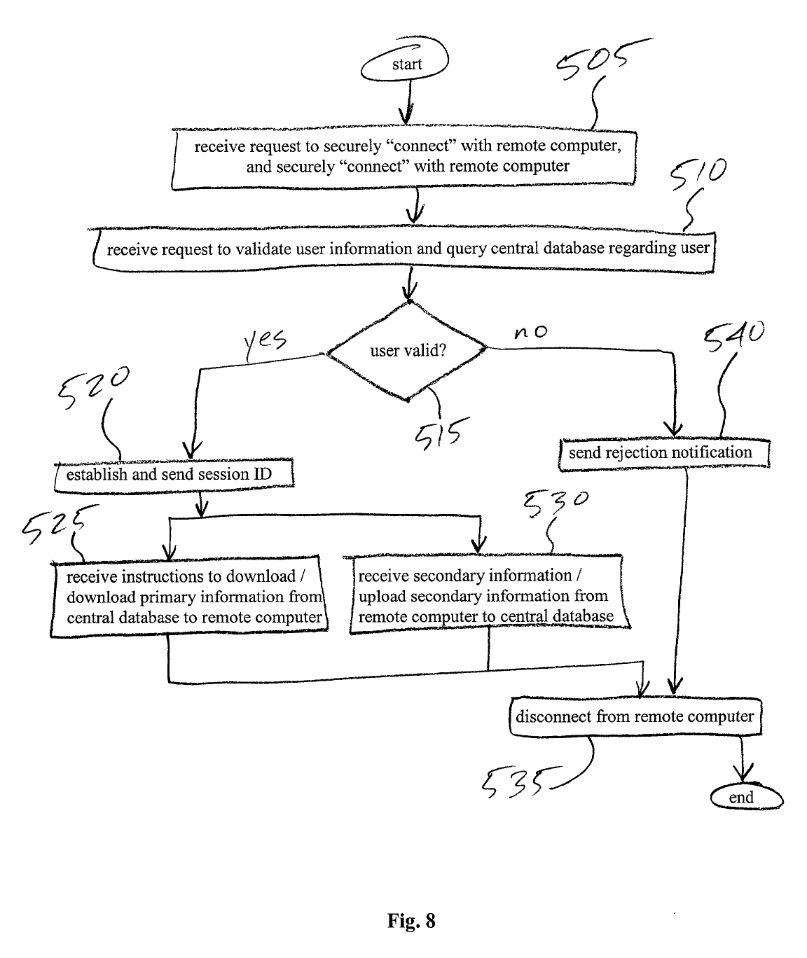

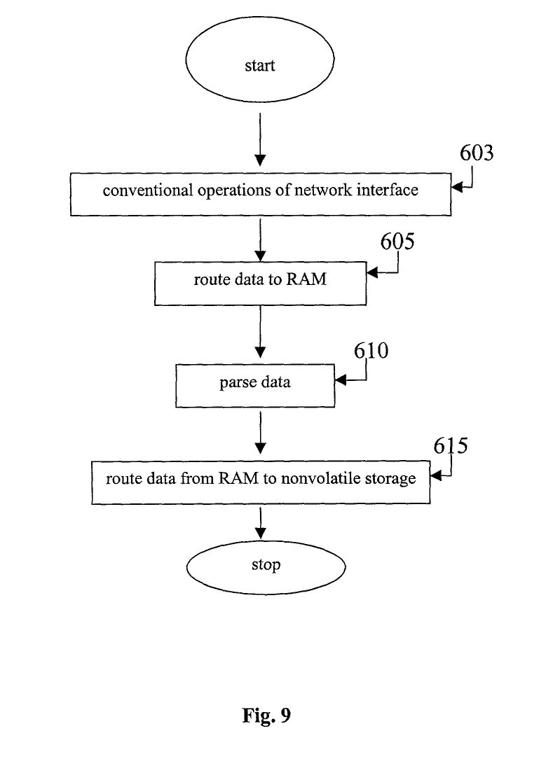

FIG. 9 is a flowchart that is illustrative of streaming operations that are performed by both the web site 62 while the information is uploaded from the remote database 94 to the central database 64 at step 530 of FIG. 8, and the downloaded program 86 while the information is downloaded from the central database 64 to the remote database 94 at step 440 of FIG. 7. The operations of the flowchart of FIG. 9 will now be described in accordance with the first embodiment of the present invention.

Referring to FIGS. 2 and 9 and for the web server 22, the information uploaded to the web server 22 at step 530 of FIG. 8 is introduced to the web server 22 via the network interface 46 thereof in a conventional manner at step 603 of FIG. 9. Similarly and for the representative remote computer 24, the information downloaded to the representative remote computer 24 at step 440 of FIG. 7 is introduced to the representative remote computer 24 via the network interface 46 thereof in a conventional manner at step 603 of FIG. 9. The operations of the network interfaces 46 of the web server 22 and the remote computers 24 at step 603 are conventional and should be understood by those of ordinary skill in the art.

The operations of FIG. 9 will now be described with respect to the representative computer 32 of FIG. 2, and these operations described with reference to the representative computer 32 are representative of operations within the web server 22 during the uploading at step 530 of FIG. 8, and representative of the operations within the remote computers 24 during the downloading at step 440 of FIG. 7. Referring to FIGS. 2 and 9, the information introduced to the representative computer 32 at step 603 is routed to RAM 52 at step 605, with there preferably not being any intermediary step(s) between steps 603 and 605, and with the information preferably being routed from the network interface 46 to RAM 52 at step 605. The information routed to RAM 52 at step 605 is parsed using the respective parser (i.e., using the parser 78 (FIG. 3) for the web server 22 and using the parser 108 (FIG. 4) for the remote computers 24) at step 610. The information parsed at step 610 is routed from RAM 52 to the respective nonvolatile computer-readable storage medium 58 (i.e., to the nonvolatile computer-readable storage medium 58a (FIG. 3) of the web server 22 during uploading and to the nonvolatile computer-readable storage medium 58b (FIG. 4) of the respective remote computer 24 during downloading) at step 615. More specifically, the parsed information is routed from RAM 52 to and written to the respective database (i.e., the central database 64 (FIG. 3) of the web server 22 during uploading and the remote database 94 of the respective remote computer 24 during downloading) at step 615.

That is and after the conventional operations performed in conjunction with the network interface 46 of the web server 22 at step 603, one or more software modules (e.g., the communication software module 66 (FIG. 3) or more specifically the parser 78 (FIG. 3) and steaming module 80 (FIG. 3)) are operative so that the uploaded information is parsed at the web server 22 prior to the uploaded information being stored upon any nonvolatile computer-readable storage medium of the web server. Similarly and after the conventional operations performed in conjunction with the network interface 46 of the representative remote computer 24 at step 603, one or more software modules (e.g., the communication software module 96 (FIG. 4) or more specifically the parser 108 (FIG. 4) and steaming module 110 (FIG. 4)) are operative so that the downloaded information is parsed at the representative remote computer 24 prior to the downloaded information being stored upon any nonvolatile computer-readable storage medium of the representative remote computer.

Primary and Secondary Information

In accordance with the first embodiment of the present invention, the data management system 20 (FIG. 1) is operative for tracking time and expense information. More specifically, the central and remote databases 64 (FIG. 3) and 94 (FIG. 4) are manipulated so that they contain/so that the primary components 72 and 98 respectively thereof include primary information 112, namely client, project, task and expense code information. FIG. 10 abstractly and diagrammatically illustrates primary information 112, respectively listed under a Client/Project heading, an Expense Code heading, and an Activity Code heading, that can be contained in the primary component 72 of the central database 64 and the primary component 98 of the remote database 94.

Briefly summarizing some of the operations discussed above with reference to FIGS. 5-8 in view of FIG. 10, the downloadable program 70 (FIG. 3) is downloaded to a representative remote computer 24 (FIG. 1), installed, and executed, which results in screen display(s)/option(s) being presented on the monitor 54 of the representative remote computer. One presented option allows for the entry of user information, namely login and password information, which must be entered before synchronization occurs. Another presented option is to synchronize, which is selected by the user so that primary information, such as the primary information 112 of FIG. 10, is downloaded from the central database 64 to the remote database 94 on the representative remote computer 24. Thereafter, the user of the remote computer 24 can enter time and expense entries. For example, the user can navigate through screen displays and options that are presented on the monitor 54 of the representative remote computer due to execution of the downloaded program 86 (FIG. 4) thereon to select a client/project from the primary information 112, thereafter they can select to make either a new expense or new time entry, and thereafter they can make the expense or time entry and select a “save” button to create secondary information, namely a time record (for example see the empty and exemplary time record 114 of FIG. 12) or an expense record (for example see the empty and exemplary expense record 116 of FIG. 11).

FIG. 11 diagrammatically illustrates secondary information, namely a representative, yet empty, expense record 116, that is generally representative of expense records that are contained in the secondary component 74 of the central database 64 and the secondary component 100 of the remote database 94; and FIG. 12 diagrammatically illustrates secondary information, namely a representative, yet empty, time record 114, that is generally representative of time records that are contained in the secondary component 74 of the central database 64 and the secondary component 100 of the remote database 94, all in accordance with the first embodiment of the present invention.

Briefly summarizing some of the operations discussed above with reference to FIGS. 5-8 in view of FIGS. 11-12 and in accordance with the first embodiment of the present invention, it is preferably records (for example see the records 116 and 114 of FIGS. 11-12) that are uploaded from the remote databases 94 of the remote computers 24 to the central database 64 of the web site 62 on the web server 22.

Second Embodiment

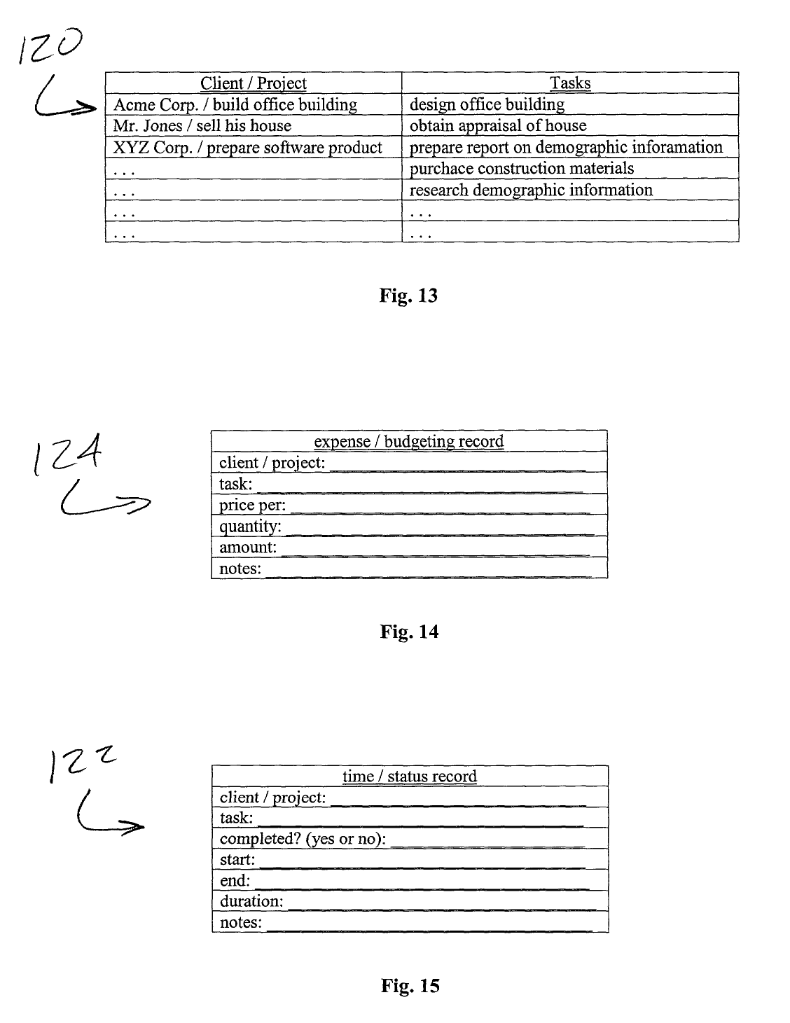

A second embodiment of the present invention is substantially similar to the first embodiment of the present invention, except for variations noted and variations that will be readily apparent to those of ordinary skill in the art. In accordance with the second embodiment of the present invention, the data management system 20 is operative for tracking project management information. Accordingly, the central and remote databases 64 (FIG. 3) and 94 (FIG. 4) are manipulated so that they contain/so that the primary components 72 and 98 respectively thereof include primary information 120, namely client, project, and task (or assignment) information. FIG. 13 abstractly and diagrammatically illustrates primary information 120, respectively listed under a Client/Project heading and a Tasks heading, that can be contained in the primary component 72 of the central database 64 and the primary component 98 of the remote database 94.

Briefly summarizing some of the operations discussed above with reference to FIGS. 5-8 in view of FIG. 13, the downloadable program 70 (FIG. 3) is downloaded to a representative remote computer 24 (FIG. 1), installed, and executed, which results in screen display(s)/option(s) being presented on the monitor 54 of the representative remote computer. One presented option allows for the entry of user information, namely login and password information, which must be entered before synchronization occurs. Another presented option is to synchronize, which is selected by the user so that primary information, such as the primary information 120 of FIG. 13, which is representative of the user's “to do” list, is downloaded from the central database 64 to the remote database 94 on the representative remote computer 24. Thereafter, the user of the remote computer 24 can navigate through screen displays and options that are presented on the monitor 54 of the representative remote computer due to execution of the downloaded program 86 (FIG. 4) to create secondary information, namely a time/status record (for example see the empty and exemplary time/status record 122 of FIG. 15) or an expense/budgeting record (for example see the empty and exemplary expense/budgeting record 124 of FIG. 14).

FIG. 14 diagrammatically illustrates secondary information, namely a representative, yet empty, expense/budgeting record 124, that is generally representative of expense/budgeting records that are contained in the secondary component 74 of the central database 64 and the secondary component 100 of the remote database 94; and FIG. 15 diagrammatically illustrates secondary information, namely a representative, yet empty, time/status record 122, that is generally representative of time/status records that are contained in the secondary component 74 of the central database 64 and the secondary component 100 of the remote database 94, all in accordance with the second embodiment of the present invention.

In accordance with a third embodiment of the present invention, the data management system 20 is operative for both tracking time and expense information, as described above for the first embodiment of the present invention, and tracking project management information, as described above for the second embodiment of the present invention.

Block Diagrams, Flowcharts and Control Flows

FIGS. 3-15 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means or devices for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means or devices which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means or devices for performing the specified functions, combinations of steps for performing the specified functions and program instruction means or devices for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A database management system that passes information via the Internet, comprising:
a web server including a first database containing information and a web site that includes web pages for providing access to the first database;
a second computer including:
a web browser for accessing the first database via the Internet and the web site and for operating with the web site to allow a user of the second computer to manipulate the information in the first database in real time,
a second database containing information, and
a first software module for accessing the second database and for allowing a user of the second computer to manipulate the information in the second database in real time while the second computer is disconnected from the Internet and the web site; and
one or more second software modules for causing the first database to include at least some of the information of the second database by uploading information from the second database to the first database via the Internet and the web server after the information in the second database has been manipulated via the first software module, whereby the database management system is operative to allow the user of the second computer to manipulate the first database in nonreal time.

2. A database management system according to claim 1, wherein the first software module is operative for preventing the user of the second computer from manipulating at least some of the information that is in the second database in response to the uploading.

3. A database management system according to claim 1, wherein the information includes information for tracking time.

4. A database management system according to claim 1, wherein the information includes information for tracking expenses.

5. A database management system according to claim 1, wherein the information includes information for tracking projects.

6. A database management system according to claim 1, wherein:
the web server further includes a parser, a nonvolatile computer-readable storage medium, and a network interface via which the uploaded information is received by the web server; and
the one or more second software modules are operative in conjunction with the parser so that after the network interface has completed its operations upon a portion of the uploaded information, the portion of the uploaded information is parsed at the web server prior to the portion of the uploaded information being stored upon any nonvolatile computer-readable storage medium of the web server.

7. A database management system according to claim 6, wherein the first database is at least partially contained by the nonvolatile computer-readable storage medium of the web server.

8. A database management system according to claim 6, wherein the one or more second software modules includes an uploading software module of the second computer, with the uploading software module being operative for at least initiating the uploading of the information from the second database to the first database via the Internet and the web server.

9. A database management system according to claim 8, wherein the one or more second software modules further includes a third software module of the web server, with the third software module being operative in conjunction with the parser so that after the network interface has completed its operations upon a portion of the uploaded information, the portion of the uploaded information is parsed at the web server prior to the portion of the uploaded information being stored upon any nonvolatile computer-readable storage medium of the web server.

10. A database management system according to claim 1, wherein the one or more second software modules are further for causing the second database to include at least some of the information of the first database by downloading information from the first database to the second database via the Internet and the web server after the information in the first database has been manipulated via the web browser, whereby the database management system is operative to allow the user of the second computer to manipulate the second database in nonreal time.

11. A database management system according to claim 10, wherein:
the web server further includes a parser, a nonvolatile computer-readable storage medium, and a network interface via which the uploaded information is received by the web server;
the second computer further includes a parser, a nonvolatile computer-readable storage medium, and a network interface via which the downloaded information is received by the second computer; and
the one or more second software modules include:
one or more third software modules of the second computer that are operative for at least initiating both the uploading of information from the second database to the first database via the Internet and the web server and the downloading of information from the first database to the second database via the Internet and the web server,
a fourth software module of the web server that is operative in conjunction with the parser of the web server so that after the network interface of the web server has completed its operations upon a portion of the uploaded information, the portion of the uploaded information is parsed at the web server prior to the portion of the uploaded information being stored upon any nonvolatile computer-readable storage medium of the web server, and
a fifth software module of the second computer that is operative in conjunction with the parser of the second computer so that after the network interface of the second computer has completed its operations upon a portion of the downloaded information, the portion of the downloaded information is parsed at the second computer prior to the portion of the downloaded information being stored upon any nonvolatile computer-readable storage medium of the second computer.

12. A database management system that passes information via the Internet, comprising:
a web server including a parser, a nonvolatile computer-readable storage medium, a first database containing information, and a network interface via which information from the Internet is received by the web server;
a second computer including a second database containing information; and
one or more software modules for uploading information from the second database to the first database via the Internet and the web server, wherein the one or more software modules are operative in conjunction with the parser so that after the network interface has completed its operations upon a portion of the uploaded information, the portion of the uploaded information is parsed at the web server prior to the portion of the uploaded information being stored upon any nonvolatile computer-readable storage medium of the web server.

13. A database management system according to claim 12, wherein the first database is at least partially contained by the nonvolatile computer-readable storage medium of the web server.

14. A database management system according to claim 12, wherein the second computer includes a first software module for accessing the second database and for allowing a user of the second computer to manipulate the information in the second database in real time.

15. A database management system according to claim 12, wherein:
the web server has a web site that includes web pages for providing access to the first database; and
the second computer includes a web browser for accessing the first database via the Internet and the web site and for operating in conjunction with the web site to allow a user of the second computer to manipulate the information in the first database in real time.

16. A database management system according to claim 15, wherein the information includes information for tracking time.

17. A database management system according to claim 15, wherein the information includes information for tracking expenses.

18. A database management system according to claim 15, wherein the information includes information for tracking projects.

19. A database management system according to claim 12, wherein the one or more software modules includes a first software module of the second computer, with the first software module being operative for at least initiating the uploading of the information from the second database to the first database via the Internet and the web server.

20. A database management system according to claim 19, wherein the one or more software modules further includes a second software module of the web server, with the second software module being operative in conjunction with the parser so that after the network interface has completed its operations upon a portion of the uploaded information, the portion of the uploaded information is parsed at the web server prior to the portion of the uploaded information being stored upon any nonvolatile computer-readable storage medium of the web server.

21. A database management system according to claim 12, wherein:
the second computer further includes a parser, a nonvolatile computer-readable storage medium, and a network interface via which information from the Internet is received by the second computer; and
the one or more software modules include:
a first software module of the second computer that is operative for at least initiating both the uploading of information from the second database to the first database via the Internet and the web server and downloading information from the first database to the second database via the Internet and the web server,
a second software module of the web server that is operative in conjunction with the parser of the web server so that after the network interface of the web server has completed its operations upon a portion of the uploaded information, the portion of the uploaded information is parsed at the web server prior to the portion of the uploaded information being stored upon any nonvolatile computer-readable storage medium of the web server, and
a third software module of the second computer that is operative in conjunction with the parser of the second computer so that after the network interface of the second computer has completed its operations upon a portion of the downloaded information, the portion of the downloaded information is parsed at the second computer prior to the portion of the downloaded information being stored upon any nonvolatile computer-readable storage medium of the second computer.

22. A method of managing information via the Internet, comprising:
downloading via the Internet information from a first database of a web server to a second database of a second computer;
then manipulating information in the second database in real time, while the second computer is not connected to the Internet; and
then uploading via the Internet at least some of the information from the second database to the first database, whereby the information in the first database is manipulated in nonreal time.

23. A method according to claim 22, further comprising manipulating information in the first database of the web server in real time via the Internet, prior to the downloading from the first database to the second database, whereby the information in the second database is manipulated in nonreal time.

24. A method according to claim 23, wherein the information includes information for tracking time.

25. A method according to claim 23, wherein the information includes information for tracking expenses.

26. A method according to claim 23, wherein the information includes information for tracking projects.

27. A method according to claim 22, further comprising downloading an application program via the Internet from a web site of the web server prior to the downloading of the information from the first database, wherein the downloaded application program performs the operations of at least initiating the downloading of the information from a first database, manipulating information in the first database, and at least initiating the uploading of the information to the first database.

28. A computer-readable medium having instructions stored thereon for performing the operations recited in claim 22.

29. A method according to claim 22, further comprising preventing the manipulation of at least some of the information in the second database in response to the uploading.

30. A computer-readable medium having instructions stored thereon for performing the operations recited in claim 29.

31. A method of manipulating information in a database maintained at a web server, comprising:
uploading information to a database of the web server, wherein the uploading includes:
operating a network interface of the web server to introduce a portion of the uploaded information to the web server, and
parsing the portion of the uploaded information at the web server prior to the portion of the uploaded information being stored upon any nonvolatile computer-readable storage medium of the web server, with the parsing occurring after the operating of the network interface with respect to the portion of the uploaded information is complete.

32. A method according to claim 31, wherein the information includes information for tracking time.

33. A method according to claim 31, wherein the information includes information for tracking expenses.

34. A method according to claim 31, wherein the information includes information for tracking projects.

35. A computer-readable medium having instructions stored thereon for performing the operations recited in claim 31.

36. A method according to claim 31, wherein the uploading includes writing the parsed in formation to the database.

37. The method of claim 36, wherein the writing the parsed information to the database includes writing the parsed information to a computer-readable storage medium of the web server.
